(19) United States
(12) Patent Application Publication
(10) Pub. No.: US 2019/0221419 A1
(43) Pub. Date: Jul. 18, 2019

(54) METHOD AND FOUR-DIMENSIONAL MICROSCOPE FOR MEASURING INTERFACIAL PHOTOELECTRON TRANSFER AND PHOTO-CATALYTIC ACTIVITIES OF MATERIALS

(71) Applicant: CENTRAL CHINA NORMAL UNIVERSITY, Wuhan (CN)

(72) Inventors: Hongying ZHONG, Wuhan (CN); Juan ZHANG, Wuhan (CN); Ruowei JIANG, Wuhan (CN); Wenyang ZHANG, Wuhan (CN); Xuemei TANG, Wuhan (CN)

(21) Appl. No.: 16/367,462

(22) Filed: Mar. 28, 2019

Related U.S. Application Data
(63) Continuation of application No. PCT/CN2017/103142, filed on Sep. 25, 2017.

(30) Foreign Application Priority Data
Sep. 28, 2016 (CN) 201610860753.9
Oct. 11, 2016 (CN) 201610887230.3

(51) Int. Cl. H01J 49/40; H01J 49/02; H01J 49/04

(52) U.S. Cl. CPC H01J 49/405; H01J 49/0468; H01J 49/0422; H01J 49/025

(57) ABSTRACT

The four-dimensional microscope includes a sample plate, a laser device, an aperture, an extraction plate, a hexapole, a quadrupole, a time-of-flight mass analyzer, a detector, and a device for supplying a voltage to the sample plate, the aperture, the extraction plate and the hexapole and the quadrupole. By utilizing the tunneling effect of photo-induced electrons on surfaces of semiconductor materials under laser irradiation and the electron capture ionization, mass-to-charge ratios and signal intensities of the ions resulting from the capture of interfacially transferred photo-induced electrons and subsequent photo-chemical reactions are measured, and image reconstruction is performed to obtain microscopic images. By using the present invention, not only active photo-catalytic sites of the semiconductor materials are imaged but also various structures of intermediates and products of photo-chemical reactions can be determined.

### CROSS-REFERENCE TO RELATED APPLICATIONS

This application is a continuation application of International Patent Application No. PCT/CN2017/103142, filed Sep. 25, 2017, which itself claims priority to Chinese Patent Application No. 201610860753.9 and 201610887230.3, filed Sep. 28, 2016 and Oct. 11, 2016, respectively, in the State Intellectual Property Office of P.R. China, which are hereby incorporated herein in their entireties by reference.

### FIELD OF THE INVENTION

The present invention relates to the field of chemistry, and more particularly, to a method and a four-dimensional microscope for measuring interfacial photoelectron transfer and photo-catalytic activities of materials.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions.

Heterogeneous interfacial photoelectron transfer is a key link in photo-catalytic reaction, and real-time monitoring of a heterogeneous electron transfer process and the intermediate transition state of the photo-catalytic reaction as well as the measurement of reaction products play important roles in understanding solar energy conversion, environmental pollutant photo-degradation, and the like. At present, methods for measuring interfacial photoelectron transfer and photo-catalytic activities of materials include three categories: (1) an overall averaging method, such as surface enhanced Raman spectrometry (SERS) and fluorescence spectroscopy: the method cannot reflect the difference between individual active photo-catalytic sites of the material and cannot identify unknown photo-catalytic reaction products or intermediate products; (2) single molecule fluorescence spectrometry: by utilizing the fluorescence generated by target products (such as superoxide negative ions) generated by photo-catalytic reaction with probe molecules, the method can perform high-resolution fluorescence imaging on individual active photo-catalytic sites, but the method cannot identify unknown photo-catalytic reaction products or intermediate products; and (3) a scanning electron micro-analyzer: the method requires a sample to be in a high vacuum state and therefore cannot reflect interfacial photoelectron transfer and photo-catalytic activities as well as variation with time under actual reaction conditions.

Therefore, a heretofore unaddressed need exists in the art to address the aforementioned deficiencies and inadequacies.

### SUMMARY OF THE INVENTION

An objective of the present invention is to provide a method and a four-dimensional microscope for measuring interfacial photoelectron transfer and photo-catalytic activities of materials.

In one aspect of the invention, the four-dimensional microscope for measuring interfacial photoelectron transfer and photo-catalytic activities of materials comprises a sample plate, a laser device, an aperture, an extraction plate, a hexapole, a quadrupole, a time-of-flight mass analyzer and a detector which are sequentially arranged, and a device for supplying a voltage to the sample plate, the aperture, the extraction plate and the hexapole, wherein the laser device is configured to emit laser pulses to the sample plate, an electrostatic field exists between the sample plate and the aperture, the time-of-flight mass analyzer is used for measuring mass-to-charge ratios of ions, the detector is configured to detect signal intensities of ions, and then, image reconstruction is performed to obtain a microscopic image.

In one embodiment, the sample plate and the laser device are positioned in a sample chamber, and the sample chamber is in an atmospheric pressure condition or vacuum condition; the aperture, the extraction plate, the hexapole, the quadrupole, the time-of-flight mass analyzer and the detector are positioned in a vacuum system.

In one embodiment, an electrostatic electron lens is arranged between the sample plate and the aperture and is configured to implement focusing and transmission of ions, the electrostatic electron lens is positioned in a sample chamber, and the sample chamber is in an atmospheric pressure condition or vacuum condition.

In one embodiment, the four-dimensional microscope further comprises a control system for laser pulses and electrostatic field synchronization or delay that is configured to control synchronization or delay of the laser pulses and the electrostatic field.

In one embodiment, the wavelength, the spot size, the pulse frequency, the pulse width and the laser incidence angle of the laser device are adjustable.

In one embodiment, the strength of the electrostatic field and the electric field direction of the electrostatic field are adjustable; therefore, under the action of the electrostatic field, a semiconductor material in a sample placed on the sample plate generates interfacically transferred photo-induced electrons, an electron acceptive molecule in the sample placed on the sample plate captures the interfacially transferred photo-induced electrons to obtain positive ions and/or negative ions, the ions pass through the aperture and are focused by the extraction plate, the hexapole and the quadrupole, finally the mass-to-charge ratios of the ions are measured by the time-of-flight mass analyzer, the signal intensities of the ions are detected by the detector, and image reconstruction is performed to obtain the microscopic image.

The method for measuring interfacial photoelectron transfer and photo-catalytic activities of materials comprises the following steps:

(1) preparing a to-be-detected semiconductor material suspension, or sticking a semiconductor material on a conductive substrate to prepare a to-be-detected semiconductor material sample;

(2) cleaning a sample plate, sucking the to-be-detected semiconductor material suspension, dripping the to-be-detected semiconductor material suspension on a surface of the sample plate, naturally airing the surface of the sample plate, then dripping an electron acceptive molecule solution on a surface of the semiconductor material, and naturally airing the surface of the semiconductor material to obtain a to-be-detected semiconductor material sample in which an electron acceptive molecule is adsorbed; or soaking and covering the to-be-detected semiconductor material sample with the electron acceptive molecule solution, naturally airing the to-be-detected semiconductor material sample to obtain the to-be-detected semiconductor material sample in which the electron acceptive molecule is adsorbed, and fixing the to-be-detected semiconductor material sample in which the electron acceptive molecule is adsorbed on the sample plate.

(3) putting the sample plate into a sample chamber, setting parameters of a laser device according to the properties of the semiconductor material, and operating the laser device to emit laser pulses to the sample plate.

An aperture, an extraction plate, a hexapole and a quadrupole are arranged behind the sample plate, an electrostatic field exists between the sample plate and the aperture, the strength of the electrostatic field is adjustable, and the electric field direction of the electrostatic field is adjustable. Therefore, under the action of the electrostatic field, photo-induced electrons tunnel away from surfaces of semiconductor materials, the electron acceptive molecule captures the interfacially transferred photo-induced electrons to obtain positive ions and/or negative ions, and then, the ions are detected in a negative ion detection mode or a positive ion detection mode. In the negative ion detection mode, the semiconductor material generates the interfacially transferred photo-induced electrons, the electron acceptive molecule captures the interfacially transferred photo-induced electrons to obtain the negative ions to move towards the direction with higher potential in the electrostatic field, the negative ions pass through the aperture and are focused by the extraction plate, the hexapole and the quadrupole, finally mass-to-charge ratios of ions are measured by the time-of-flight mass analyzer, signal intensities of the ions are detected by the detector, and image reconstruction is performed to obtain a microscopic image. In the positive ion detection mode, the semiconductor material generates the interfacially transferred photo-induced electrons, the electron acceptive molecule captures the interfacially transferred photo-induced electrons to obtain positive ions to move towards the direction with lower potential in the electrostatic field, the positive ions pass through the aperture and are focused by the extraction plate, the hexapole and the quadrupole, finally mass-to-charge ratios of ions are measured by the time-of-flight mass analyzer, signal intensities of the ions are detected by the detector, and image reconstruction is performed to obtain a microscopic image.

In one embodiment, the electrostatic field is set according to the properties of the semiconductor material and the electron acceptive molecule, a bias voltage between the sample plate and the aperture enables the tunneling of electrons and the acceleration of photo-induced electrons away from the surfaces of the semiconductor materials, and the ions generated as soon as the electron acceptive molecule captures the photo-induced electrons are focused and transmitted in the electrostatic field between the aperture and the hexapole.

In one embodiment, the laser wavelength of the laser device is selected according to the properties and the band gap of the semiconductor material to enable the band gap of the semiconductor material to be less than laser photon energy.

In one embodiment, modes of capturing the interfacially transferred photo-induced electrons by the electron acceptive molecule include associative electron capture, dissociative electron capture and electron detachment. Under different bias voltages between the sample plate and the aperture, tunneling electrons interact with adsorbed electron acceptive molecules through associative/dissociative electron capture ionization and electron detachment ionization.

In one embodiment, by virtue of associative electron capture ionization, the electron acceptive molecule captures the photo-induced electrons to form a radical anion; by virtue of the dissociative electron capture ionization, the electron acceptive molecule captures the photo-induced electrons to induce specific chemical bond cleavages and new bond formations and generate negative fragment ions; and by virtue of the electron detachment, with high kinetic energies detach electrons from the electron acceptor molecule and generates positive ions.

In one embodiment, the semiconductor material is selected from one of SiO₂, BiOCl, Ce₂O₃, ZnO, BN, AlN, TiO₂, and Ga₂O₃.

In one embodiment, the conductive substrate is a conductive metal aluminum strip or copper strip.

In one embodiment, the semiconductor material has different exposed crystal facets, and the photo-catalytic activities of different crystal facets of the semiconductor material can be detected by adjusting the placement direction of the semiconductor material stuck on the conductive substrate.

In one embodiment, the electron acceptive molecule is selected from 5-hydroxy-1,4-naphthoquinone, 4,4′-DDT or fatty acids, but not limited to these.

In one embodiment, synchronization or delay time of the electrostatic field and the pulsed laser is controlled according to needs so as to conduct kinetic research of interaction between the photo-induced electrons and neutral molecules.

In one embodiment, the wavelength, the spot size, the pulse frequency, the pulse width and the laser incidence angle of the laser device are adjustable, and thus, more crystal facets are scanned by adjusting and controlling the wavelength, the spot size, the pulse frequency, the pulse width and the laser incidence angle of the laser device to obtain more crystal facet information.

In one embodiment, a solvent for preparing the semiconductor material suspension is isopropanol, and the concentration of the semiconductor material suspension is 10 mg/mL. In one embodiments, a solvent for preparing the electron acceptive molecule solution is acetone, and the concentration of the electron acceptive molecule solution is 5 mg/mL.

According to the invention, aiming at different samples, a sample plate cleaning solution is prepared from different ingredients. A common sample plate cleaning solution is prepared from 50% (v/v) acetone and 50% (v/v) n-hexane.

The calibration method of the negative ion detection mode in the invention comprises the following steps: preparing the to-be-detected semiconductor material into a suspension of which the concentration can be 10 mg/mL, dripping the suspension on a sample plate, and naturally airing the sample plate; dripping a fatty acid standard solution on the surface of the material, naturally airing the surface of the material, then putting the sample plate into the sample chamber, setting the sample chamber to be in a high-vacuum state, setting the parameters of the laser device, the electrostatic field and the time-of-flight mass analyzer, operating the laser device to scan the sample plate, and measuring the mass-to-charge ratios of ions and signal intensities of the negative ions generated as soon as the electron acceptive molecule captures the interfacially transferred photo-induced electrons, thereby performing calibration. The fatty acid standard solution is prepared from nine free fatty acids including C6:0, C8:0, C10:0, C12:0, C14:0, C16:0, C18:0, C20:0 and C22:0, and the fatty acids are dissolved in n-hexane, so that the concentration of the fatty acids is 5 mg/mL. The calibration method of the positive ion detection mode is the same as the calibration method of the negative ion detection mode but with different reagent. It uses polyethylene glycol (PEG) as the calibration reagent.

The present invention has the following beneficial effects:

(1) By utilizing the tunneling effect of photo-induced electrons on surfaces of semiconductor materials under laser irradiation and the electron capture ionization, mass-to-charge ratios and signal intensities of the ions resulting from the capture of interfacially transferred photo-induced electrons and subsequent photo-chemical reactions are measured, and image reconstruction is performed to obtain microscopic images. By using the present invention, not only active photo-catalytic sites of the semiconductor materials are imaged but also various structures of intermediates and products of photo-chemical reactions can be determined.

(2) Compared with an existing fluorescence spectrophotometer which is based on the measurement of light emission, by the tunneling effect of photo-induced electron on surfaces of semiconductor materials under laser irradiation and the electron capture ionization, resultant ions are structurally identified. Because the time-of-flight mass analyzer has a full scanning function, the strength of the electrostatic field is adjustable, the delay time is adjustable and the laser wavelength, the spot size, the pulse frequency and width are also adjustable, by adopting the four-dimensional microscope of the present invention, the capability to detect photo-induced electron transfer and various photo-catalytic reaction products is greatly enhanced, and the detection limitation of the fluorescence spectrometry is overcome. Meanwhile, by adjusting and controlling the electric field direction of the electrostatic field, the negative ion detection mode and the positive ion detection mode can be performed to achieve the detection of both positive ions and negative ions.

(3) Compared with an existing scanning electron microscope which requires the sample to be in a high vacuum state, the present invention can measure interfacial photoelectron transfer and photo-chemical reactions in an atmospheric pressure state, and can perform microscopic imaging of active photo-catalytic sites under actual conditions. Furthermore, the present invention can perform real-time measurement under the atmospheric condition, and can monitor the change of interfacial photoelectron transfer and active photo-catalytic sites with time, thereby being favorable for studies of photo-electric properties of materials.

(4) The present invention is easy in control of operation processes, high in analytical speed, small in background interference, free of radiation or chemical pollution, high in spatial resolution, high in mass accuracy and stable in property, is especially suitable for measurement and microscopic imaging of interfacial electron transfer and photo-catalytic activities of the semiconductor material, and is convenient for quality control and application.

(5) The four-dimensional microscope for measuring interfacial photoelectron transfer and photo-catalytic activities of materials in the present invention is innovative in design, the composition is simple and easily available, and the used reagents and parts are environmentally friendly, and it is safe and practical.

These and other aspects of the present invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 shows a schematic diagram of the four-dimensional microscope according to one embodiment of the invention: sample plate 1, laser device 2, aperture 3, extraction plate 4, hexapole 5, quadrupole 6, time-of-flight mass analyzer 7, detector 8, and device 9 for supplying a voltage.

FIG. 2 shows a working schematic diagram of the four-dimensional microscope according to one embodiment of the invention.

FIG. 3 shows a negative ion spectrum obtained under different bias voltages between the sample plate and the aperture in the negative ion detection mode according to Embodiment 1 of the invention.

FIG. 4 shows a positive ion spectrum obtained in the positive ion detection mode and a negative ion spectrum obtained in the negative ion detection mode, wherein the bias voltage between the sample plate and the aperture is 0.1 v, and in the spectra, the horizontal coordinate represents the mass-to-charge ratio and the vertical coordinate represents the relative ion intensities of ions.

FIG. 5 shows a positive ion spectrum obtained in an electrostatic field in which the bias voltage between the sample plate and the aperture is 60 v in the positive ion detection mode according to Embodiment 2 of the invention.

FIG. 6 shows microscopic images of photo-catalytic activities of the exposed <100> crystal facet and side facet of titanium dioxide with 5-hydroxy-1,4-naphthoquinone as electron acceptive molecules according to Embodiment 3 of the invention.

FIG. 7 shows microscopic images of 4,4′-DDT on the exposed <100> crystal facet and side facet of titanium dioxide and photo-chemical reaction products with persistent organochlorine pollutant 4,4′-DDT as electron acceptive molecules according to Embodiment 4 of the invention.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the present invention.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” to another feature may have portions that overlap or underlie the adjacent feature.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” or “includes” and/or “including” or “has” and/or “having” when used in this specification specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation shown in the figures. For example, if the device in one of the figures is turned over, elements described as being on the “lower” side of other elements would then be oriented on the “upper” sides of the other elements. The exemplary term “lower” can, therefore, encompass both an orientation of lower and upper, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around,” “about,” “substantially” or “approximately” shall generally mean within 20 percent, preferably within 10 percent, and more preferably within 5 percent of a given value or range. Numerical quantities given herein are approximate, meaning that the terms “around,” “about,” “substantially” or “approximately” can be inferred if not expressly stated.

As used herein, the phrase “at least one of A, B, and C” should be construed to mean a logical (A or B or C), using a non-exclusive logical OR. As used herein, the term “and/or” includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

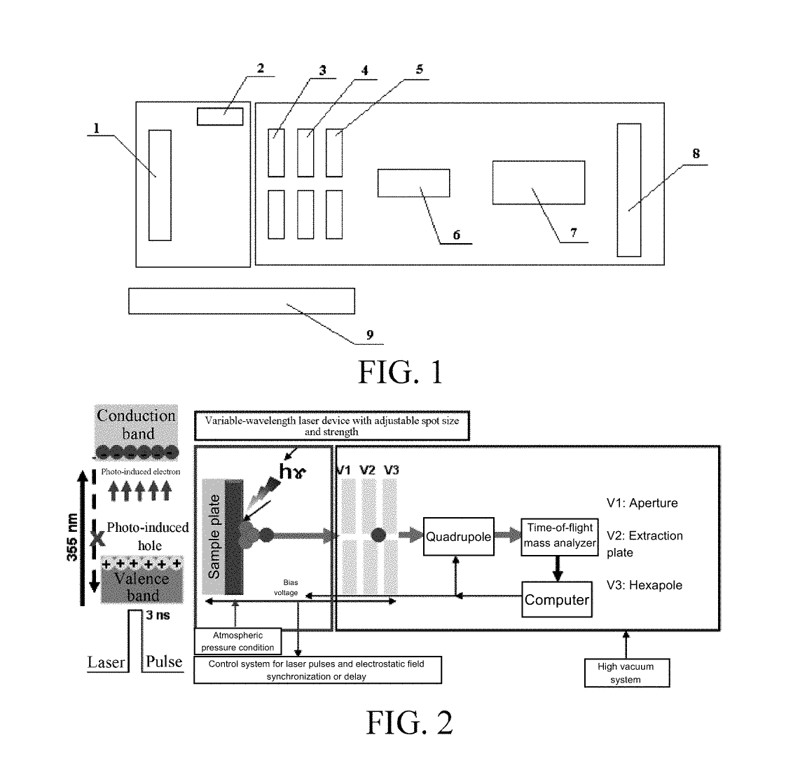

As shown in FIGS. 1 and 2, the four-dimensional microscope for monitoring interfacial photoelectron transfer and photo-catalytic activities of materials comprises a sample plate, a laser device, aperture, extraction plate, hexapole, quadrupole, a time-of-flight mass analyzer and a detector which are sequentially arranged, and further comprises a device for supplying a voltage to the sample plate, the aperture, the extraction plate and the hexapole, wherein the laser device is configured to emit pulse laser to the sample plate, an electrostatic field exists between the sample plate and the hexapole, the time-of-flight mass analyzer is used for measuring mass-to-charge ratios of ions, the detector is configured to detect the ion intensities, and then, image reconstruction is performed to obtain microscopic images of active photo-catalytic sites. The sample plate and the laser device are positioned in a sample chamber, and the sample chamber is in an atmospheric pressure condition. The aperture, the extraction plate, the hexapole, the quadrupole, the time-of-flight mass analyzer and the detector are positioned in a vacuum system.

Further, electrostatic electron lenses can also be arranged in the sample chamber and between the sample plate and the aperture and are used for focusing and transmission of ions. Further, the four-dimensional microscope also comprises a control system that is configured to control synchronization or delay time of the pulse laser and the electrostatic field.

### Embodiment 1

A method for measuring interfacial photoelectron transfer and active photo-catalytic sites of titanium dioxide nano-particles comprises the following steps:

(1) preparation of a titanium dioxide semiconductor nano-material suspension: weighing 10 mg of nano-material, dissolving the weighed nano-material in 1 mL of isopropanol, and performing ultrasonic vibration for 1 min to enable nano-particles to be uniformly dispersed;

(2) preparation of an electron acceptive molecule solution: weighing 100 mg of 5-hydroxy-1,4-naphthoquinone, and dissolving the weighed 5-hydroxy-1,4-naphthoquinone in 1 ml of acetone to prepare the electron acceptive molecule solution;

(3) cleaning the sample plate, dripping 1 μL of the titanium dioxide semiconductor nano-material suspension on the sample plate, and naturally airing the sample plate; dripping 1 μL of the electron acceptive molecule solution on the surface of the titanium dioxide semiconductor nano-material, and naturally airing the surface of the titanium dioxide semiconductor nano-material;

(4) putting the sample plate into the mass spectrometer, in the negative ion detection mode, adjusting the pressure and temperature of the sample chamber, and adjusting the voltages on the sample plate, the aperture, the hexapole and the extraction plates to enable the bias voltage between the sample plate and the aperture to be 20 V, 30 V and 60 V respectively;

(5) setting laser parameters (for example, laser wavelength is set to be 355 nm but not limited to 355 nm), so that laser photon energy to be greater than the band gap of the semiconductor material, operating the laser device to emit pulse laser to the sample plate, synchronously applying the electrostatic field, enabling interfacially transferred photo-induced electrons on surfaces of semiconductor materials, enabling the electron acceptive molecule to capture the interfacially transferred photo-induced electrons to form negative ions or enabling the electron acceptive molecule to capture the interfacially transferred photo-induced electrons to induce specific chemical bond cleavages to obtain negative fragment ions, enabling the obtained negative ions to move towards the direction with high potential in the electrostatic field and pass through the aperture so as to be focused by electron lens and the hexapole and the quadrupole, finally measuring the mass-to-charge ratio by the time-of-flight mass analyzer, detecting the ion intensities by the detector, collecting data, and performing image reconstruction to obtain microscopic images of active photo-catalytic sites.

(6) calibrating the spectra obtained in step (5) with the exact masses of C6:0, C8:0, C10:0, C12:0, C14:0, C16:0, C18:0, C20:0 and C22:0.

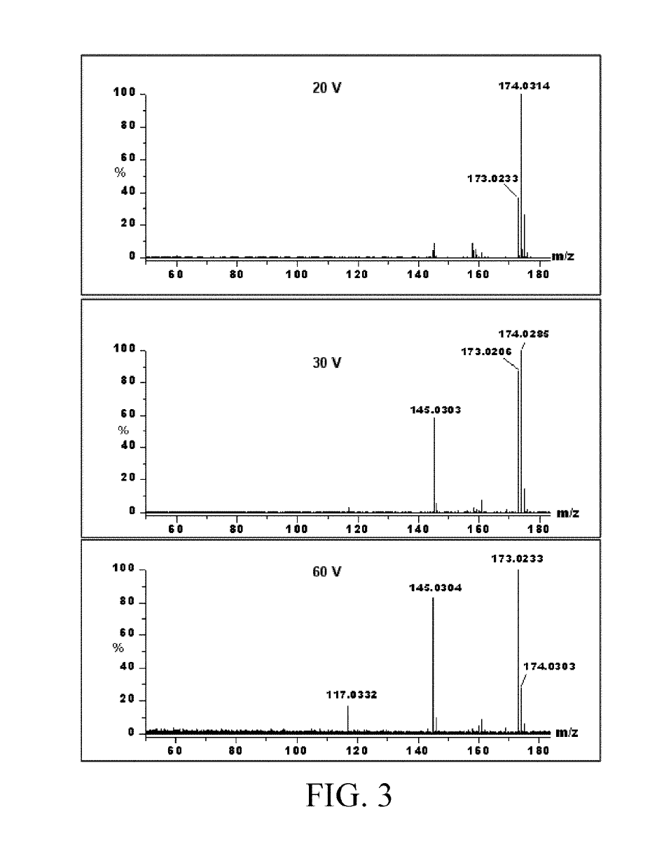

In this embodiment, the bias voltage between the sample plate and the aperture can be set as 20 V, 30 V and 60 V respectively, and the obtained spectrum is shown in FIG. 3. In FIG. 3, when the bias voltage is 20 V, 30 V or 60 V, associative and dissociative electron capture ionization can be found (different fragment ions are generated), wherein the ion at m/z 174 is a radical anion generated by the exothermal capture of electrons tunneling away from the surface of semiconductor materials by neutral molecules. Further losses of a H atom, one or two CO molecules result in the formation of ions at m/z 173, 145 and 117 respectively.

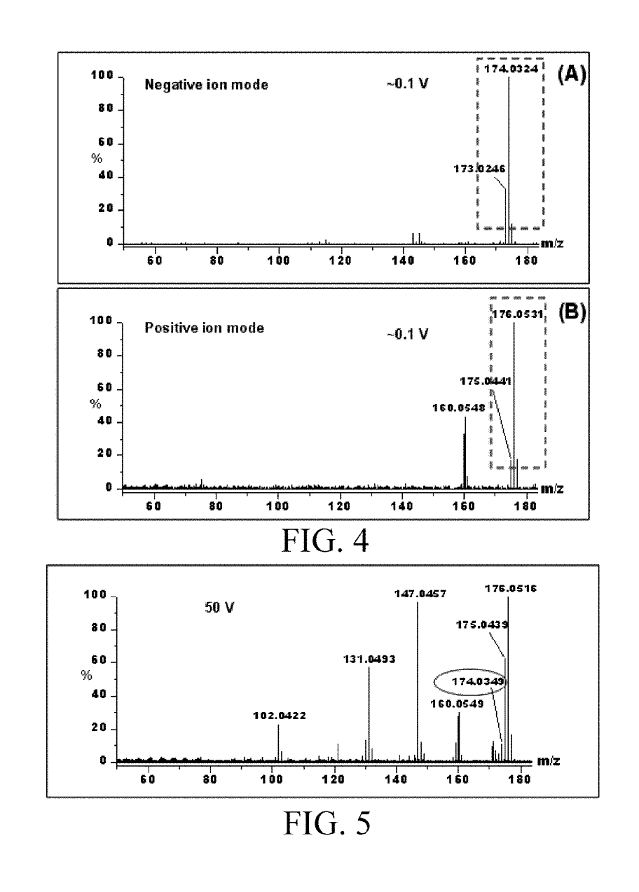

In this embodiment, the bias voltage between the sample plate and the aperture is set to be 0.1 V, mass-to-charge ratios of the ions are detected in a positive ion mode and a negative ion mode respectively, and results are shown in FIG. 4, wherein panel (A) is the spectrum obtained in the negative ion mode, and panel (B) is the spectrum obtained in the positive ion mode. The negative ions resulting from the capture of photo-induced electrons by electron acceptive molecules firstly bind with one proton because of electrostatic interaction, and then, atoms with lone pair electrons bind with another additional proton. Then the net charge is +1. It is shown in FIG. 4 that the electron acceptive molecule capture the interfacially transferred photo-induced electrons to form negative ions. Thereby it is confirmed that when the bias voltage is 0.1 V, the electron acceptive molecules undergo associative electron capture ionization.

### Embodiment 2

In this embodiment, the positive ion detection mode was applied to measure interfacial photoelectron transfer and active photo-catalytic sites of the titanium dioxide nanoparticles. The specific method is the same as that in the embodiment 1 except that in the positive ion detection mode, the bias voltage between the sample plate and the aperture is set to be 50 V, the resultant positive ion spectrogram is shown in FIG. 5, which illustrates the electron detachment from the electron acceptive molecules. Under the bias voltage of 50 V, accelerated electrons with high kinetic energies bombard with the neutral molecules to enable the escape of electrons with low ionization potential in the molecules, thereby generating radical cations at m/z 174.

### Embodiment 3

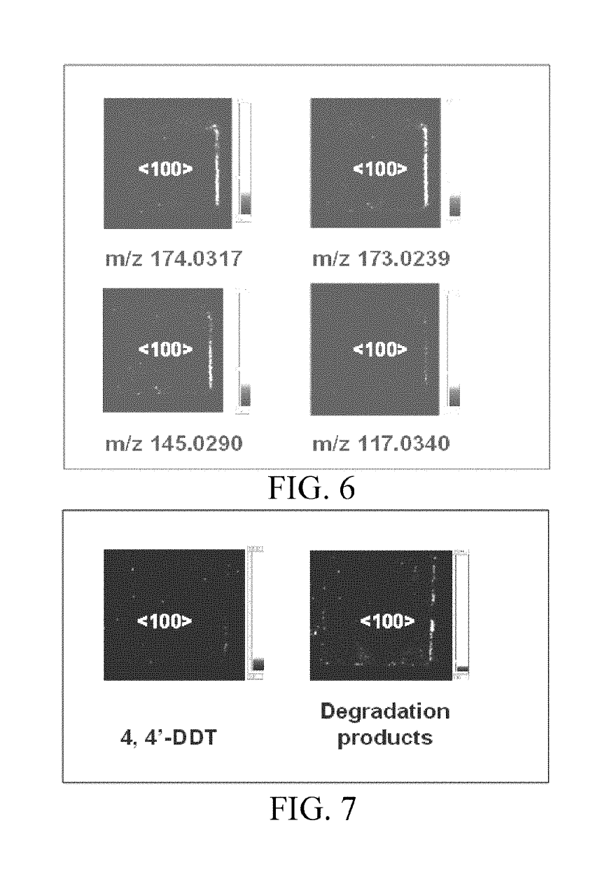

This embodiment measures the photoelectron transfer and active photo-catalytic sites of the exposed <100> crystal facet and side facet of titanium dioxide. The specific method is the same as that in the embodiment 1 except that in preparation of the sample plate, the titanium dioxide is soaked and covered with a 5-hydroxy-1,4-naphthoquinone solution, the titanium dioxide adsorbed with 5-hydroxy-1,4-naphthoquinone is fixed on a conductive metal aluminum strip or copper strip, the <100> crystal facet is upward, and the bias voltage between the sample plate and the aperture is set as 20 V. The detection results are shown in FIG. 6. It can be seen from FIG. 6 that the intensities of ions on the exposed <100> crystal facet of the titanium dioxide is very low, which illustrates the poor photo-catalytic properties, but the side surface (non-<100> crystal facet) of the titanium dioxide shows stronger ion intensities, which illustrates more active photo-catalytic sites.

### Embodiment 4

A method for microscopic images of active photo-catalytic sites of the exposed <100> crystal facet and side facet of the titanium dioxide with persistent organochlorine pollutant 4,4′-DDT as electron acceptive molecule comprises the following steps:

(1) preparing an electron acceptive molecule solution: weighing 100 mg of 4,4′-DDT, and dissolving the weighed 4,4′-DDT in 1 mL of acetone;

(2) soaking and covering the crystal surface of the titanium dioxide with the 4,4′-DDT solution obtained in step (1), and naturally airing the crystal surface of the titanium dioxide;

(3) sticking the titanium dioxide crystal obtained in step (2) on the surface of an aluminum strip or a copper strip, and then, fixing the aluminum strip or the copper strip on the cleaned sample plate, wherein the <100> crystal facet is upward;

(4) putting the sample plate into the mass spectrometer, in the negative ion detection mode, adjusting the pressure and temperature of the sample chamber, setting the parameters of the electrostatic electron lens, and adjusting the voltages on the sample plate, the aperture, the hexapole, the quadrupole and the extraction plates to enable the bias voltage between the sample plate and the aperture to be 20 V respectively;

(5) setting laser parameters (laser wavelength is set to be 355 nm), enabling laser photon energy to be greater than the band gap of the semiconductor material, operating the laser device to emit pulse laser to the sample plate, synchronously applying the electrostatic field, enabling interfacial transfer of photo-induced electrons, enabling the electron acceptive molecules to capture the interfacially transferred photo-induced electrons, enabling the generation of negative or positive ions, enabling resultant ions to move towards the direction with high or low potential in the electrostatic field and pass through the aperture so as to be focused by the hexapole and the quadrupole, finally measuring the mass-to-charge ratios by the time-of-flight mass analyzer, detecting ion intensities by the detector, and collecting data.

(6) calibrating the spectrum obtained in step (5) with the exact mass of C6:0, C8:0, C10:0, C12:0, C14:0, C16:0, C18:0, C20:0 and C22:0, and performing image reconstruction to obtain microscopic images of 4,4′-DDT and photo-catalytic sites.

In this embodiment, the bias voltage between the sample plate and the aperture is 20 V respectively, and the microscopic images of 4,4′-DDT and photo-chemical reaction products are shown in FIG. 7. It can be seen from FIG. 7 that 4,4′-DDT can serve as the electron acceptive molecule to capture the interfacially transferred photo-induced electrons, by associative or dissociative capture ionization. As soon as capturing the photo-induced electrons, 4,4′-DDT molecules undergoes photo-chemical reaction and chemical bond cleavages and new bond formations so as to generate fragment ions (photo-chemical reaction products).

The foregoing description of the exemplary embodiments of the invention has been presented only for the purposes of illustration and description and is not intended to be exhaustive or to limit the invention to the precise forms disclosed. Many modifications and variations are possible in light of the above teaching.

While there has been shown several and alternate embodiments of the present invention, it is to be understood that certain changes can be made as would be known to one skilled in the art without departing from the underlying scope of the invention as is discussed and set forth above and below including claims and drawings. Furthermore, the embodiments described above are only intended to illustrate the principles of the present invention and are not intended to limit the scope of the invention to the disclosed elements.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in the description of this invention are incorporated herein by reference in their entireties and to the same extent as if each reference was individually incorporated by reference.

What is claimed is:

1. A four-dimensional microscope for measuring interfacial photoelectron transfer and photo-catalytic activities of materials, comprising:
a sample plate, a laser device, an aperture, an extraction plate, a hexapole, a quadrupole, a time-of-flight mass analyzer and a detector which are sequentially arranged, and a device for supplying voltages to the sample plate, the aperture, the extraction plate and the hexapole and the quadrupole,
wherein the laser device is configured to emit pulse lasers to the sample plate, an electrostatic field exists between the sample plate and the aperture, the time-of-flight mass analyzer is configured to measure mass-to-charge ratios of ions, the detector is configured to detect signal intensities of the ions, and image reconstruction is performed to obtain a microscopic image.

2. The four-dimensional microscope for measuring interfacial photoelectron transfer and photo-catalytic activities of materials according to claim 1, wherein the sample plate and the laser device are positioned in a sample chamber, and the sample chamber is in an atmospheric pressure or vacuum condition; the aperture, the extraction plate, the hexapole, the quadrupole, the time-of-flight mass analyzer and the detector are positioned in a vacuum system.

3. The four-dimensional microscope for measuring interfacial photoelectron transfer and photo-catalytic activities of materials according to claim 1, wherein an electrostatic electron lens is arranged between the sample plate and the aperture and is configured to implement focusing and transmission of ions, the electrostatic electron lens is positioned in a sample chamber, and the sample chamber is in an atmospheric pressure or vacuum condition.

4. The four-dimensional microscope for measuring interfacial photoelectron transfer and photo-catalytic activities of materials according to claim 1, further comprising a control system for laser pulses and electrostatic field synchronization or delay that is configured to control synchronization or delay of the laser pulses and the electrostatic field.

5. The four-dimensional microscope for measuring interfacial photoelectron transfer and photo-catalytic activities of materials according to claim 1, wherein the wavelength, the spot size, the pulse frequency, the pulse width and the laser incidence angle of the laser device are adjustable.

6. The four-dimensional microscope for measuring interfacial photoelectron transfer and photo-catalytic activities of materials according to claim 1, wherein the strength of the electrostatic field and the electric field direction of the electrostatic field are adjustable; therefore, under the action of the electrostatic field, a semiconductor material placed on the sample plate generates interfacical transfer photo-induced electrons, an electron acceptive molecule on the sample plate captures the interfacially transferred photo-induced electrons to obtain positive ions and/or negative ions, the ions pass through the aperture and are focused by the extraction plate, the hexapole and the quadrupole, finally the mass-to-charge ratios of the ions are measured by the time-of-flight mass analyzer, the signal intensities of the ions are detected by the detector, and image reconstruction is performed to obtain the microscopic image.

7. A method for measuring interfacial photoelectron transfer and photo-catalytic activities of materials, comprising the following steps:
(a) preparing a to-be-detected semiconductor material suspension, or sticking a semiconductor material on a conductive substrate to prepare a to-be-detected semiconductor material sample;
(b) cleaning a sample plate, sucking the to-be-detected semiconductor material suspension, dripping the to-be-detected semiconductor material suspension on a surface of the sample plate, naturally airing the surface of the sample plate, dripping an electron acceptive molecule solution on a surface of the semiconductor material, and naturally airing the surface of the semiconductor material to obtain a to-be-detected semiconductor material sample in which an electron acceptive molecule is adsorbed; or soaking and covering the to-be-detected semiconductor material sample with the electron acceptive molecule solution, naturally airing the to-be-detected semiconductor material sample to obtain the to-be-detected semiconductor material sample in which the electron acceptive molecule is adsorbed, and fixing the to-be-detected semiconductor material sample in which the electron acceptive molecule is adsorbed on the sample plate; and
(c) putting the sample plate into a sample chamber, selecting a laser parameter of a laser device according to the properties of the semiconductor material, and operating the laser device to emit pulse laser to the sample plate,
wherein an aperture, an extraction plate, a hexapole and a quadrupole are arranged behind the sample plate, an electrostatic field exists between the sample plate and the aperture, the strength of the electrostatic field is adjustable, and the electric field direction of the electrostatic field is adjustable; whereby, under the action of the electrostatic field, photo-induced electrons tunnel away from surfaces of semiconductor materials, the electron acceptive molecule captures the interfacially transferred photo-induced electrons to obtain positive ions and/or a negative ions, and the ions are detected in a negative ion detection mode or a positive ion detection mode; in the negative ion detection mode, the semiconductor material generates the interfacially transferred photo-induced electrons, the electron acceptive molecule captures the interfacially transferred photo-induced electrons to obtain the negative ions to move towards the direction with high potential in the electrostatic field, the negative ions pass through the aperture and are focused by the extraction plate, the hexapole and the quadrupole, finally mass-to-charge ratios of ions are measured by the time-of-flight mass analyzer, signal intensities of the ions are detected by a detector, and image reconstruction is performed to obtain a microscopic image; in the positive ion detection mode, the semiconductor material generates the interfacially transferred photo-induced electrons, the electron acceptive molecule captures the interfacially transferred photo-induced electrons to obtain positive ions to move towards the direction with low potential in the electrostatic field, the positive ions pass through the aperture and are focused by electrons lens, the hexapole and the quadrupole, finally mass-to-charge ratios of ions are measured by the time-of-flight mass analyzer, signal intensities of the ions are detected by the detector, and image reconstruction is performed to obtain a microscopic image.

8. The method for measuring interfacial photoelectron transfer and photo-catalytic activities of materials according to claim 7, wherein the electrostatic field is set according to the properties of the semiconductor material and the electron acceptive molecule, a bias voltage between the sample plate and the aperture enables the tunneling of electrons and the acceleration of photo-induced electrons away from the surfaces of the semiconductor materials, and the ions generated as soon as the electron acceptive molecule captures the photo-induced electrons is focused and transmitted in the electrostatic field between the aperture and the sample plate.

9. The method for measuring interfacial photoelectron transfer and photo-catalytic activities of materials according to claim 7, wherein the laser wavelength of the laser device is selected according to the properties and the band gap of the semiconductor material to enable the band gap of the semiconductor material to be less than laser photon energy.

10. The method for measuring interfacial photoelectron transfer and photo-catalytic activities of materials according to claim 7, wherein modes of capturing the interfacially transferred photo-induced electrons by the electron acceptive molecule include associative electron capture, dissociative electron capture and electron detachment.

11. The method for measuring interfacial photoelectron transfer and photo-catalytic activities of materials according to claim 10, wherein by virtue of associative electron capture ionization, the electron acceptive molecule captures the photo-induced electrons to form a radical anion; by virtue of the dissociative electron capture ionization, the electron acceptive molecule captures the photo-induced electrons to induce specific chemical bond cleavages and new bond formations and generate negative fragment ions; and by virtue of the electron detachment, with high kinetic energies detach electrons from the electron acceptor molecule and generates positive ions.

12. The method for measuring interfacial photoelectron transfer and photo-catalytic activities of materials according to claim 7, wherein the semiconductor material is selected from one of SiO₂, BiOCl, Ce₂O₃, ZnO, BN, AlN, TiO₂, and Ga₂O₃.

13. The method for measuring interfacial photoelectron transfer and photo-catalytic activities of materials according to claim 7, wherein the conductive substrate is a conductive metal aluminum strip or copper strip.

14. The method for measuring interfacial photoelectron transfer and photo-catalytic activities of materials according to claim 7, wherein the semiconductor material has different exposed crystal facets, and the photo-catalytic activities of different crystal facets of the semiconductor materials can be detected by adjusting the placement direction of the semiconductor material stuck on the conductive substrate.

15. The method for measuring interfacial photoelectron transfer and photo-catalytic activities of materials according to claim 7, wherein the electron acceptive molecule is selected from 5-hydroxy-1,4-naphthoquinone, 4,4′-DDT, fatty acids.

16. The method for measuring interfacial photoelectron transfer and photo-catalytic activities of materials according to claim 7, wherein synchronization or delay time of the electrostatic field and the pulse laser is adjusted and controlled according to needs.

17. The method for measuring interfacial photoelectron transfer and photo-catalytic activities of materials according to claim 7, wherein the wavelength, the spot size, the pulse frequency, the pulse width and the laser incidence angle of the laser device are adjustable, and more crystal facets are scanned by adjusting and controlling the wavelength, the spot size, the pulse frequency, the pulse width and the laser incidence angle of the laser device to obtain more crystal facet information.
